(19) United States
(12) Patent Application Publication
(10) Pub. No.: US 2007/0253668 A1
(43) Pub. Date: Nov. 1, 2007

(54) Method of Producing Germanosilicate with a High Refractive Index Change

(75) Inventors: Kantisara Pita, Singapore (SG); Rajni, Amstardam (NL); Swae Chuan Tjin, Singapore (SG); Chan Hin Kam, Singapore (SG); Siu Fung Yu, Singapore (SG)

Correspondence Address: FOLEY & LARDNER LLP, P.O. BOX 80278, SAN DIEGO, CA, 92138-0278, US

(73) Assignee: Nanyang Technological University, Singapore (SG)

(21) Appl. No.: 11/792,199

(22) PCT Filed: Dec. 7, 2005
(86) PCT No.: PCT/SG05/00414

§ 371 Date: Jun. 1, 2007

Related U.S. Application Data
(60) Provisional application No. 60/634,499, filed on Dec. 8, 2004.

(51) Int. Cl. C01B 33/20

(52) U.S. Cl. 385/123

(57) ABSTRACT

The present invention relates to a method of producing germanosilicate. The formed germanosilicate comprises a refractive index change Δn. The method includes forming a gel from a sol comprising germaniumoxide, or a precursor thereof, and silicate, or a precursor thereof, by means of a sol-gel process. The method further includes forming germanosilicate by annealing the gel under elevated temperature and exposing the formed germanosilicate to pulsed UV light of at least 350 mJ/pulse.

### FIELD OF THE INVENTION

The present invention relates to a method of producing germanosilicate that includes a refractive index change Δn (within the formed germanosilicate). The invention also relates to the formation of a waveguide, including a waveguide that can be used in optical circuits. The method of the invention includes forming a gel from a sol comprising germaniumoxide and silicate by means of a sol-gel process. The method further includes forming germanosilicate by annealing the gel under elevated temperature and exposing the formed germanosilicate to pulsed UV light of at least 350 mJ/pulse.

### BACKGROUND OF THE INVENTION

Optical circuits such as planar lightwave circuits (PLCs) are used in a variety of applications, for example in the area of communication systems. PLC functional devices such as channel waveguides, array waveguides (AWG), and other waveguide based devices, are for instance essential for the realization of high-speed optical telecommunication network. In photonic integrated circuit devices, a variety of semiconductor optoelectronic devices are monolithically integrated and interconnected with waveguides. The telecommunications industry uses integrated optics for multigigabit bidirectional communication data transmission, signal splitting and loop distribution. In Community Access Television (CATV) for example, modules that include optical circuits are used for external modulation in fiber-optic-based signal distribution systems. The conventional approach for fabricating waveguide-based devices involves depositions of waveguiding core materials, photolithography, etching and deposition of over-cladding materials [Zuo, L. et al., Optics Letters, 28 (2003) 12, 1046-1048; Holmes, A. S., et al., Applied Optics, 32 (1993) 4916-4921]. This approach requires many steps and complex processes.

Micro-scale optical components such as guiding channels can also be formed by illuminating photosensitive materials with ultraviolet (UV) radiation to induce refractive index changes, a method known as the direct writing technique. A laser is focused onto the desired workpiece, optionally by means of a mask, and a desired pattern or shape is written by moving either the beam itself or the respective workpiece. This simple fabrication technique has attracted considerable interest since, compared to traditional lithographic techniques, it involves fewer steps and does not require the use of etchants. Furthermore, by means of direct writing it is possible to form smooth interfaces in buried channel waveguides. The use of lasers in the process also allows for flexibility and for the creation of waveguides with novel shapes such as unique curves and bends.

However, the fabrication of waveguide based devices by the direct writing technique requires a high refractive index change (Δn) by UV illumination, which demands an appropriate choice of photosensitive materials. So far this has been achieved by using polymers such as polymethyl-methacrylate or organic materials. These materials are not very stable, show low performance due to poor mechanical resistance, and need low temperature functioning environment. An alternative is the use of photosensitive inorganic silica based glasses. They have a high reliability and good compatibility with optical fiber, are of low cost and of good performance with low propagation loss (<0.3 dB) in doped silica waveguides [Zhang, Q. Y. et al., Chemical Physics Letters 368 (2003) 183-188; Zhang, Q. Y. et al., Chemical Physics Letters 379 (2003) 534-538]. Silica (SiO₂) glasses containing germanium dioxide have attracted considerable interest because germanium dioxide is well established as an iso-structural analogue of SiO₂ and is sensitive to UV.

Silica glass materials can be deposited by flame hydrolysis deposition (FHD), plasma enhanced chemical vapor deposition (PECVD), inductive coupled plasma enhanced chemical vapor deposition (ICP-CVD) and the sol-gel method. The latter is a chemical process that has inherent advantages over other small-scale fabrication methods since it allows for flexible chemistry, and the resulting materials are both homogenous and of high purity. It is furthermore a low-cost method, which is flexible with respect to design and material changes such as dopants. Additionally it allows for the fabrication of large-area coatings where required. When combined with a coating technique it is a promising route to synthesize doped silica based materials (e.g. Ho, C. K. F. et al., Proceedings of the 11^{th} European Conference on Integrated Optics, [2003] 305-308). It offers the flexibility to tailor the optical properties and to control the molecular structure of the materials through chemistry and processes.

Doped silica based materials are typically required when used with a silica optical telecommunications fiber, in order to match the refractive index of the waveguide materials of the planar optical device to that of the fiber. The transmission of light via optical fibers by means of total reflection is achieved by a difference of optical refractive indices between a cladding portion of silica glass and a core portion, in which elements such as germanium (Ge) are added, thereby slightly increasing the refractive index. Thus the refractive index difference for the waveguide materials can likewise be achieved by doping with germanium. Germanium doped silica glasses (germanosilicate) have already been widely used for photosensitive fiber brag gratings (FBG) and waveguide based devices for optical communication [see e.g. Miyake, Y. et al., Journal of Non-Crystalline Solids, 222 (1997) 266-271].

However, the refractive index change induced by UV radiation is mostly in the order of 10⁻⁵˜10⁻⁴, which is too small to be able to form waveguiding channels.

Accordingly it is an object of the present invention to provide a method of obtaining a refractive index change that is suitable for the formation of waveguiding channels in germanosilicate that has been fabricated by the sol-gel method.

### SUMMARY OF THE INVENTION

In one aspect the present invention provides a method of producing germanosilicate. The formed germanosilicate possesses a refractive index change Δn.

In a further aspect the invention provides a method of forming a waveguide that can be used in optical circuits.

The methods include forming a gel from a sol comprising germaniumoxide, or a precursor thereof, and silicate, or a precursor thereof, by means of a sol-gel process. The method further includes forming germanosilicate by annealing the gel under elevated temperature. The method also includes exposing the formed germanosilicate to UV light of at least 350 mJ/pulse.

In yet a further aspect the invention relates to germanosilicate comprising a refractive index change Δn, obtainable by a method of the present invention.

In yet another aspect the invention relates to a waveguide obtainable by a method of the present invention.

### BRIEF DESCRIPTION OF THE DRAWINGS

The invention will be better understood with reference to the detailed description when considered in conjunction with the non-limiting examples and the accompanying drawings, in which:

FIG. 1 depicts the increase of the refractive indices of ˜200 nm thick films annealed at various temperatures as a function of UV radiation time. Changes in refractive index (Δn) were compared at a wavelength of 1550 nm for the films (GeO₂:SiO₂ 1:4) prepared at various annealing temperatures (without a consolidation heat treatment). Δn was monitored after various time periods of UV radiation. It can be observed that the refractive index change is higher for films annealed at higher temperature. Furthermore Δn increases significantly within 1 min of UV-exposure. Beyond 1 min, the increase is small and roughly linear with exposure time. For the dense films of the depicted example a refractive index change (Δn) of about 10⁻² was obtained after UV illumination in excess of 1 minute.

FIG. 2: A layer (GeO₂:SiO₂ 1:4) of about 3 μm thickness was generated by repeated coating of films. Each layer was annealed at 900° C. and after a thick film had been obtained the thick film was subsequently consolidated at 1000° C. in a furnace in air atmosphere. The refractive index change (Δn) induced by the UV radiation (λ=248 nm, 20 min exposure) was investigated as a function of the exposure time at 450 mJ/pulse. The refractive index increases by about 5×10⁻³ in about 20 minutes and then increases slowly thereafter. This refractive index change is sufficient to generate a guiding channel.

FIG. 3 shows the refractive index change of ˜3 μm thick films (GeO₂:SiO₂ 1:4) UV radiated for 20 minutes at different fluencies. After a repeated coating of films and subsequent annealing of each layer at 900° C. a thick film had been obtained. The thick film was subsequently consolidated at 1000° C. in a furnace in air atmosphere. At 250 mJ/pulse, Δn is small below 1×10⁻³, which is not high enough to form e.g. a wave guiding channel. At 350 mJ/pulse, Δn is about 3×10⁻³, and value large enough for the formation of a guiding channel.

FIG. 4 depicts the change of refractive index (Δn) of ˜200 nm thick film (GeO₂:SiO₂ 1:4), annealed at 900° C. and UV radiated at different fluency as a function of the illumination time. As can be seen, for such thin films relatively large Δn (˜4×10⁻³) is observed at 250 mJ/pulse.

FIG. 5 shows the effect of the molar ration of GeO₂:SiO₂ on the change of the refractive index (Δn). About 200 nm thick films were prepared by spin-coating, annealed at various temperatures for 15 sec and, without a consolidation heat treatment, exposed to UV light for 20 minutes.

FIG. 6 depicts an example of the variation of the refractive index change Δn obtainable by the method of the present invention with the temperature selected for annealing. Single layer films were annealed for 15 sec in RTP. ▴: films were annealed at various temperatures without a subsequent consolidation heat treatment, and exposed to UV radiation of a KrF excimer laser for 20 min. Increasing temperatures used for annealing result in an increase of refractive index change induced by UV illumination with saturation reached around 900-1000° C. ▪: films were annealed at 900° C., subsequently exposed to a second heat treatment in a furnace for 1 hr at various temperatures, and exposed to UV radiation of an KrF excimer laser at 450 mJ/pulse for 20 min. It can be seen that in the present occasion a consolidation heat treatment at 1000° C. slightly reduced the refractive index change obtained. Furthermore the induced refractive index change (Δn) for films further heat treated at 1100° C. and above was substantially reduced.

FIG. 7 depicts the influence of the temperature selected for the second heat treatment on the refractive index change (at 1550 nm) obtainable by the method of the present invention (cf. also FIG. 6: ▪). 1GeO₂:4SiO₂ films were annealed at 900° C. for 15 sec and subjected to a further heat treatment (consolidation) at various temperatures selected above the annealing temperature for 1 hour. Films were thereafter either left untreated (▴) or exposed to UV light illumination for 20 minutes (●). At temperatures of the consolidation heat treatment of 1100° C. and above the values of both refractive indices are close to each other, thus only a very small refractive index change is obtained.

FIG. 8 depicts the refractive index (n) of dense samples at 1550 nm with 20 minutes UV illumination and different post annealing treatment: (i) film annealed at 1000° C. as deposited without subsequent illumination; (ii) a corresponding film was exposed to UV light illumination for 20 min; (iii) a respective illuminated dense sample was heat treated at 900° C. for 1 hr under argon; (iv) a respective illuminated dense sample, heat treated at 900° C. for 1 hour under oxygen. As can be seen from the values of (ii) and (iv), for the samples heat treated in oxygen atmosphere a decrease in refractive index from 1.4841±0.0004 to 1.4765±0.0005 is observed. However, for the sample annealed in inert atmosphere the refractive index remains unchanged; it is at about the same value as that after UV radiation (see FIG. 8 (ii) and (iii)). These data may suggest that the induced refractive index change is due to the creation of oxygen related defects.

FIG. 9 depicts a schematic diagram of an exemplary embodiment of a method according to the present invention. The central part of the sol-gel process, the generation of a sol that includes germaniumoxide and silicate, is marked by a dashed frame. The depicted process uses hydrolysis of a silicon alkoxide and a germanium alkoxide to prepare two separate sols. A mixture of tetraethoxysilane (TEOS) and EtOH (ethanol) was hydrolysed by adding an acid catalyst HNO₃. The obtained sol is termed sol S. A sol termed sol G was prepared by mixing tetrapropyloxygermane (TPOG) with isopropanol (IPA). A 4SiO₂: 1GeO₂ composition (sol SG) was obtained by mixing sol G and sol S. In embodiments where a thick film is generated by means of repetitive depositing and annealing (cf. subsequent steps), sol S is typically diluted before mixing with sol G. Depositing sol SG by means of spin coating on a substrate results in the depicted example.in a film. The deposited sol undergoes a catalysed transition to form a gel, which is heat treated, also termed annealing, using the rapid thermal processing (RTP) technique in the presence of O₂. Where desired the formed germanosilicate may then be exposed to a further consolidation heat treatment. This heat treatment is in the depicted embodiment performed below 1100° C. The germanosilicate is then exposed to UV radiation. By varying the exposure time the refractive index changes can conveniently be adjusted. For stabilization purposes the film may be post baked.

FIG. 10 illustrates a fabrication of a waveguide by radiating the highly photosensitive film by UV light through a mask. The highly photosensitive layer (2) is deposited and fabricated on a substrate (5). The layer is then radiated by UV light (10) through a mask (1). The refractive index n₀ is the refractive index of the densified photosensitive layer before UV radiation. The refractive index change due the UV radiation, Δn₁, can be easily adjusted by varying the exposure time (cf. FIG. 2).

FIG. 11 illustrates the fabrication of a waveguide with gratings (4) by further radiating the waveguide (still located on substrate (5)) with UV light, for the second time, through a mask (3) defining the gratings. Further increase of the refractive index Δn₂ can again be easily adjusted by varying the exposure time (cf. FIG. 2).

FIG. 12 illustrates the fabrication of a graded index waveguide using the method of the present invention. The highly photosensitive germanosilicate layer (2) is again deposited and fabricated on a substrate (5). The film is then radiated by a UV light (10) through a grey scale mask (6). The refractive index n₀ is the refractive index of the densified photosensitive film before UV radiation. The refractive index change due the UV radiation through the grey scale mask, Δn_{gs}, is a function of the transmission of the grey scale mask and the exposure time.

### DETAILED DESCRIPTION OF THE INVENTION

The present invention is based on the surprising finding that high refractive index changes Δn can be achieved by radiating germanosilicate formed by a sol-gel process with UV. This finding lead to the development of the method of the invention as explained in the following. As explained above, refractive index changes induced by UV radiation of germanosilicate were so far too small to be able to form waveguiding channels. Only recently, Sakoh et al. reported a refractive index change of about 10⁻³ in a germanosilicate glass fabricated by plasma enhanced chemical vapor deposition [Sakoh, A. et al., Optics express, 11 (2003) 21]. The method of the present invention, which uses the sol-gel process, is suitable for producing germanosilicate with a refractive index change of more than 10⁻³, including a refractive index change of more than 5×10⁻³.

The sol-gel process used in the present invention can be performed according to any protocol. The process may for example include forming two separate sols, which are then combined. One of these sols includes silica, while another one includes germaniumoxide. The silica, the germaniumoxide, or both may be formed from a precursor, for example in situ during the reaction process.

Where such a process is used, in which two separate sols are combined one sol is a silica sol, i.e. a suspension of colloidal silica-based particles, for instance nanoparticles. This sol may for instance be generated by hydrolysis of a precursor such as silicon alkoxide. The hydrolysis of a silicon alkoxide is thought to induce the substitution of OR groups linked to silicon by silanol Si—OH groups, which then lead to the formation of a silica network via condensation polymerisation. Examples of silicon alkoxides include for instance methyl silicate (Si(OMe)₄), ethyl silicate (Si(OEt)₄), propyl silicate (Si(OPr)₄), isopropyl silicate (Si(Oi-Pr)₄), pentyl silicate (Si(OCH₅H₁₁)₄), octyl silicate (Si(OC₈H₁₇)₄), isobutyl silicate (Si(OCH₂iPr)₄), tetra(2-ethylhexyl)orthosilicate (Si(OCH₂C(Et)n-Bu)₄), tetra(2-ethylbutyl)silicate (Si(OCH₂CHEt₂)₄), ethylene silicate ((C₂H₄O₂)₂Si), tetrakis(2,2,2-trifluoroethoxy)silane (Si(OCH₂CF₃)₄), tetrakis(methoxyethoxy)silane (Si(OCH₂CH₂OMe)₄), benzyl silicate or cyclopentyl. Typically, but not limited thereto, sol preparation by hydrolysis of a silicon alkoxide can be performed in a mixture of water and an alcohol such as ethanol or isopropanol. Any known catalyst such as hydrochloric acid or ammonia may be added as well. Hence, sol-gel protocols using acid-catalyzed, base-catalyzed and two-step acid-base catalyzed procedures may for instance be followed. In embodiments that employ an acid-catalysed process, the pH value may for instance be in the range of about 1 to about 4, such as for example about pH 3.

A further sol generated in a process that includes a first step of forming two sols is a germaniumoxide sol, which is typically prepared by a protocol similar to the preparation of a silica sol above. In case a protocol of hydrolysis of a germanium alkoxide is carried out, generally an alcohol such as isopropanol is used as a solvent. Typically the use of water is avoided where the germanium alkoxide is reactive/sensitive to moisture. Examples of germanium alkoxides include, but are not limited to, tetrapropyloxygerman, tetramethyloxygerman, o-phenylene germinate, ethylene germanate or 2,2′-spirobi[naphtho[1,8-de]-1,3,2-dioxagermin. Further dopants such as boron- or tin-based compounds may be used where desired, for instance in order to increase the photosensitivity of the germanosilicate layer produced.

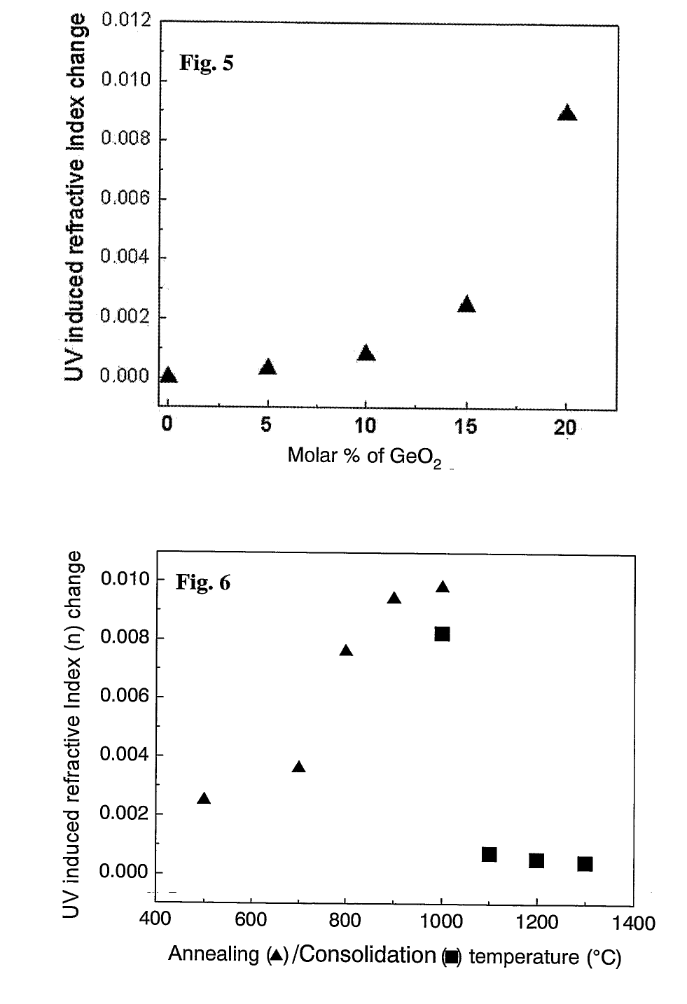

By combining these two sols in a second step a sol is obtained that contains silica and germaniumoxide. Upon varying the ratio of each sol used for mixing, a desired molar ratio of SiO₂ to GeO₂ can be generated. Where a one-step method is used to form a sol that includes germaniumoxide and silicate, the respective ratio is accordingly determined by the amounts of silica- and germaniumoxide-compounds applied. Any ratio of SiO₂ to GeO₂ may be chosen, as long as a refractive index change can be obtained (see below). Depending on the remaining conditions used, it may be advantageous to select a ratio of SiO₂ to GeO₂ in the range between 8:1 and 2:1 in order to obtain a high refractive index change (see FIG. 5). As an example, a composition of 80% mol SiO₂ and 20% mol GeO₂ (4 SiO₂: 1 GeO₂) may be chosen. Higher GeO₂ content may give a higher refractive index change (Δn).

The sol subsequently undergoes a catalysed transition (cf. above) to form a gel. Before this occurs, the sol may be transferred in order to achieve a desired form. Alternatively the sol may for instance be prepared in a device that already provides the desired final form. In some embodiments forming a gel from a sol includes contacting the sol with a substrate. Contacting the sol with a substrate may for instance include depositing the sol onto a substrate.

As an illustrative example, it may be intended to obtain germanosilicate in form of a layer. In such embodiments the sol may for instance be deposited onto a substrate such as silica glass, by for example casting, molding or in form of a coating. As already indicated above, generally the process of depositing assists the formation of a gel. In yet other embodiments contacting the sol with a substrate may be performed by immersing a respective substrate, which may be of any shape, into the sol that contains silica and germaniumoxide.

It may be desired to clean a selected substrate before generating a respective gel thereon, for instance by means of a solution of a strong base such as potassium hydroxide. While not required when using the method of the present invention, in some embodiments an undercladding may be deposited onto the substrate before depositing the germanosilicate thereon. Where a layer of germanosilicate is formed, it may be of any desired form and thickness. Thick layers may for example be produced by means of repeated coating (cf. below). Where desired, a wetting agent may be used prior to such coating. Examples of such a coating include, but are not limited to, dipping or spin coating.

The method of the present invention further includes forming germanosilicate by annealing the obtained gel under elevated temperature. Any elevated temperature may be chosen that does not prevent a later refractive index change to occur. The increase in temperature may be generated by any means, including irradiation. The exposure to an elevated temperature may be selected to also contribute to or to allow for a later refractive index change of a desired extent. In some embodiments the elevated temperature is within a range of about 500° C. to about 1000° C., for example in the range of about 800° C. to about 1000° C. In some embodiments the elevated temperature is about 900° C. An illustrative example of annealing is rapid thermal annealing (RTA) at a selected temperature. Typically layers annealed below about 900° C. are porous and layers annealed at about 900° C. and above are dense. Any period of time may be selected for annealing the gel. Typical periods of time used in the art may be employed, for example within the range of about 2 sec to about 1 minute, such as e.g. 15 sec or 20 sec. The annealing may furthermore be repeated where desired.

The refractive index change obtainable by the method of the present invention generally increases with the temperature selected for annealing up to a certain limit. An example for this tendency for embodiments where rapid thermal annealing is employed is depicted in FIG. 6 (▴). Annealing films at 800° C. and above resulted in a significant higher Δn than annealing at 500 or 700° C.

In embodiments where it is desired to generate a thick layer, for instance of a thickness in the range of about 1 μm to about 10 μm, such as 3 μm, 10 μm or 20 μm, a first thin layer may be generated by a selected technique as indicated above and thereafter annealed. Subsequently a second layer may be generated in the same or a different way and annealed as above. Where desired subsequently a third, fourth etc. layer may be deposited and annealed. Such a procedure is for example typically performed in the manufacture of waveguide based devices. Where desired, the outer periphery of a generated layer may be removed before further processing as described in US patent application 2004/0115347. This step may be chosen to address the so called “edge bead” formation in order to prevent the formation of micro-cracks at the edge of the layer.

In some embodiments the method of the present invention further includes a consolidation treatment of the annealed germanosilicate by further exposure to elevated temperature. The term “consolidation treatment” as used herein thus refers to a second exposure of annealed germanosilicate to elevated temperature, regardless of the thickness of the germanosilicate. Thus the term is for instance equally used for a respective treatment of a thin single-layer film and a film obtained by multiple layer depositions. This may for instance be performed where a density of the formed germanosilicate is desired which is higher than the density that is typically obtained during annealing as described above. This may be the case in embodiments where a thick layer of germanosilicate is generated by successive formation, e.g. deposition, of thin layers, for example. In some embodiments, such as in the manufacture of waveguide based devices, this consolidation step also helps assuring that no refractive index gradient across the thickness of a respective layer occurs. In embodiments where a thick film is generated by sequential deposition of multiple layers, the first layer is annealed many more times than e.g. the top layer (depending on the number of layers). As thus each individual layer, which becomes part of one thick layer, has been treated differently, a refractive index gradient is usually created across the thickness of the obtained thick layer.

Any treatment with an elevated temperature may be chosen that yields a desired density and that allows for a later refractive index change to occur. As an illustrative example, the germanosilicate may be heated in a furnace. Any period of time may be selected for consolidating the annealed germanosilicate. Suitable periods of time include the range of about 0.5 to about 4 hours, for example about 1 hour or about 2 hours. An optimal period of time for a certain embodiment can easily be determined experimentally.

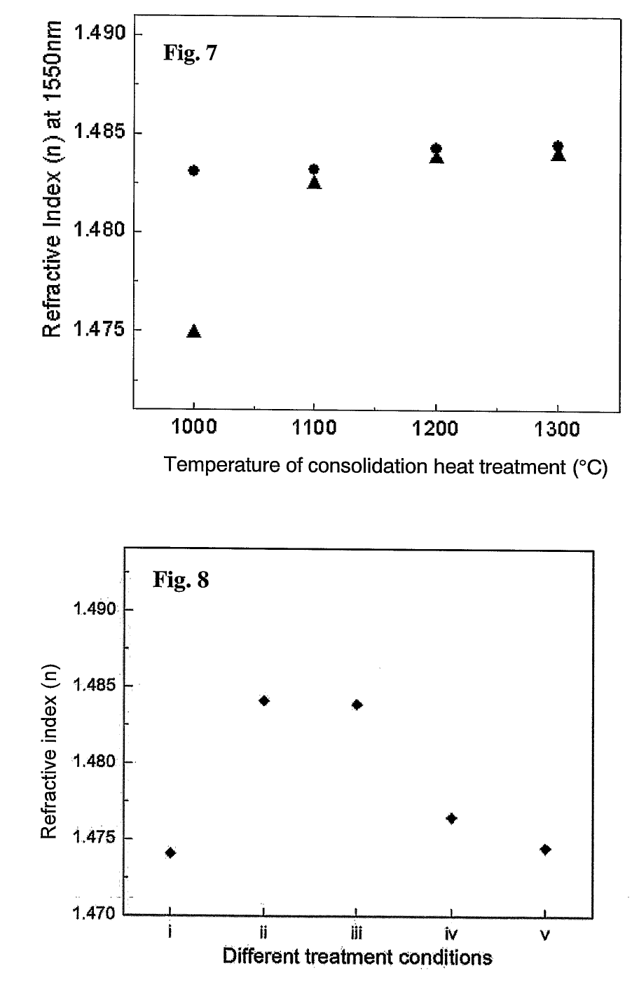

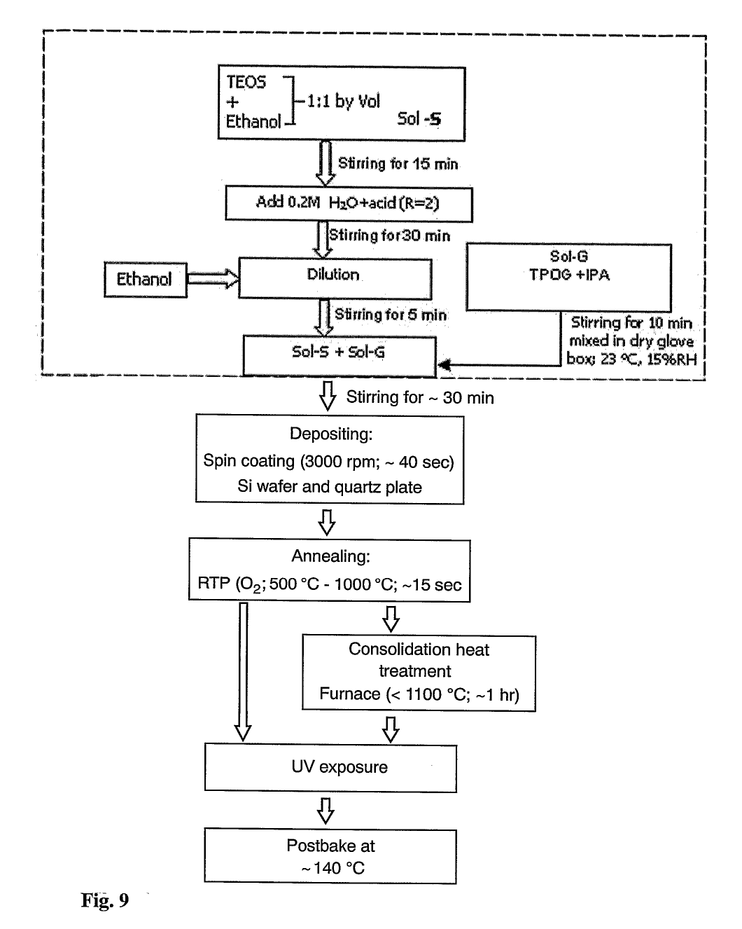

In order to obtain a high densification effect it is furthermore advantageous to carry the consolidation treatment out at a higher temperature than the temperature used for annealing. Up to ˜1000-1100° C. this consolidation step shows no or only a very moderate influence on the refractive index obtainable by the method of the present invention (compare e.g. the two values with [▪] and without [▴] a consolidation treatment at 1000° C. in FIG. 6). In some embodiments where the annealed germanosilicate is densified by a consolidation treatment, it is densified at a temperature below 1100° C. It was found here that at temperatures of the consolidation treatment of 1100° C. and above the refractive index changes obtainable are much smaller than at lower consolidation temperatures. This finding is illustrated in FIG. 6 and FIG. 7. FIG. 7 shows the refractive index n of the germanosilicate before (▴) and after (●) UV exposure. FIG. 6 shows the variation of the induced refractive index change by UV radiation (Δn) with the temperature of the consolidation treatment (as well as the annealing temperature). While a high refractive index change (i.e. the difference between ● and ▴ in FIG. 7) is obtained when using germanosilicate densified at 1000° C., a much smaller refractive index change is obtained at 1100° C. and above, although all further conditions are identical. Without wishing to be bound to theory, it is presently assumed that the as-deposited films in RTP at 900° C. are dense but the bonds are still strained and therefore are easier to break under UV exposure producing oxygen related defects and hence high Δn. When the germanosilicate is further treated for 1 hr in the furnace at 1000° C. and above, the bonds may become more relaxed and therefore may be more difficult to break to generate oxygen related defects, and hence the Δn becomes lower. Apparently, high Δn can be obtained by synthesizing a material system and developing a process to obtain strained bonds in the material (such as germanosilicate prepared by sol-gel process, or other materials or process that can produce strained bonds), followed by high intensity radiation. Furthermore, from FIG. 6, when applying consolidation heat treatment on a single layer film at 1000° C. the obtained Δn is high (˜8×10⁻³) when compared to conventional methods (supra).

Where it is for instance desired to generate a thick layer of germanosilicate and to obtain a high refractive index change, a procedure to generate a respective layer may thus be chosen that includes e.g. successive depositing of thin layers and subsequent annealing (supra), and that further includes subsequently consolidating the thick layer at a temperature below 1100° C.

The method of the invention further includes exposing the germanosilicate to UV light of an energy of at least 350 mJ/pulse. Typically the UV light is pulsed. As an illustrative example, pulsed UV light of a UV fluency of about 450 mJ/pulse may be chosen. Any UV light source may be employed to generate a respective radiation. An example of a means for the generation of one or more radiation pulses that may be used is a laser. Typically the germanosilicate is exposed to more than one UV pulse. A convenient frequency of pulses and exposure time may be selected. As an illustrative example, the repetition rate may be chosen in the range of about 5 to about 50 Hz, such as for instance about 10 Hz. The exposure time may for instance be selected within the range of about 0.5 minutes to about 5 hours or about 1 minute to about 1 hour. In typical embodiments the fabricated germanosilicate is first consolidated and thereafter exposed to a respective pulsed UV light.

The germanosilicate may be irradiated by any suitable beam form. The UV light may illuminate a part of selected area at a time or on the entire generated germanosilicate at once. As an illustrative example, the UV light may be provided as a beam, for instance in an embodiment where the UV light source is a laser. Several such beams may be provided and, where desired, overlap. In typical embodiments the UV light is of an energy density of at least 122 mJ/cm² per pulse. A respective density is for instance obtained with a laser beam of a size of about 24 mm×12 mm, where 350 mJ/pulse are applied. In some embodiments the UV light is of an energy density of at least 156 mJ/cm² per pulse. Such a density may for instance be provided by using an energy of 450 mJ/pulse with a laser beam of a size of about 24 mm×12 mm.

Electromagnetic radiation of any wavelength within the ultraviolet range may be used in the method of the present invention. In some embodiments the wavelength is for instance selected within the near UV (380 to 200 nm), while in other embodiments it is for instance selected within the far UV (200 to 10 nM). As an example, the wavelength may be selected to be 248 nm or shorter. An illustrative example of a means of providing UV light of a respective wavelength is a KrF laser. A further illustrative example is an ArF laser, which provides UV light of a wavelength of 193 nm.

The irradiation by UV light induces a change in the refractive index of the germanosilicate. Without the wish to be bound by theory it is believed that this is due to an induction of an oxygen-deficiency in the germanosilicate. The refractive index obtained was found to decrease upon a subsequent exposure to an elevated temperature in an oxygen atmosphere, while it remaining unchanged in an inert atmosphere (see FIG. 8).

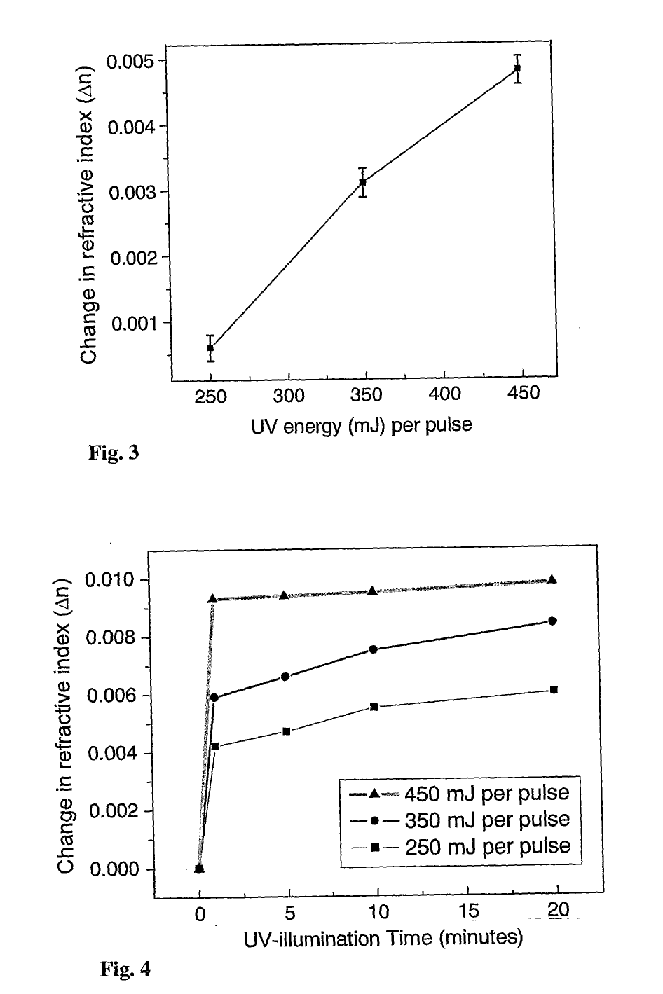

The value of Δn can be adjusted by varying the material composition, the annealing temperature, the UV radiation intensity and the exposure time. The value of Δn generally increases with increasing GeO₂ content, the radiation intensity per pulse, the number of pulse per second and the exposure time. The method of the present invention allows for a refractive index change of higher than 10⁻³, including a refractive index change of more than 5×10⁻³, after UV exposure. The influence of the GeO₂ content on the change in the refractive index is illustrated in FIG. 5. As for the UV radiation intensity (cf. above), the refractive index change usually increases with the irradiation intensity up to a certain value. An illustrative example of a correlation between the UV radiation intensity and the refractive index obtained is depicted in FIG. 3.

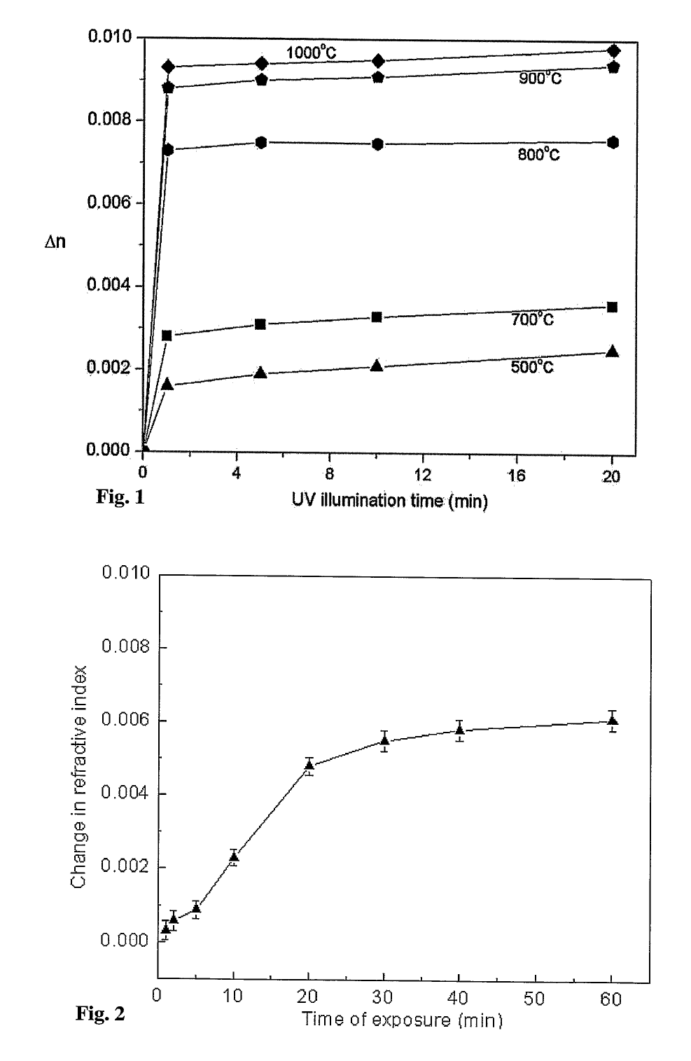

FIG. 1 illustrates the increase of the refractive indices of layers annealed at various temperatures as a function of UV radiation time. The refractive index change (Δn) is higher for layers annealed at higher temperature. Furthermore Δn typically increases with the time of exposure to UV radiation up to a point of time where either saturation is reached or where further exposure to UV light causes a gradual increase of Δn to a minor or at least significantly smaller extent (cf. FIG. 1). For layers that are about 200 nm thick this point of time is usually in the dimension of about a minute (cf. FIG. 1). For layers that are about 3 μm thick this point of time is usually in the dimension of about 20 minutes (cf. FIG. 2). Therefore a convenient means of adjusting Δn to a desired value during for example device fabrication is restraining UV exposure to a defined period of time.

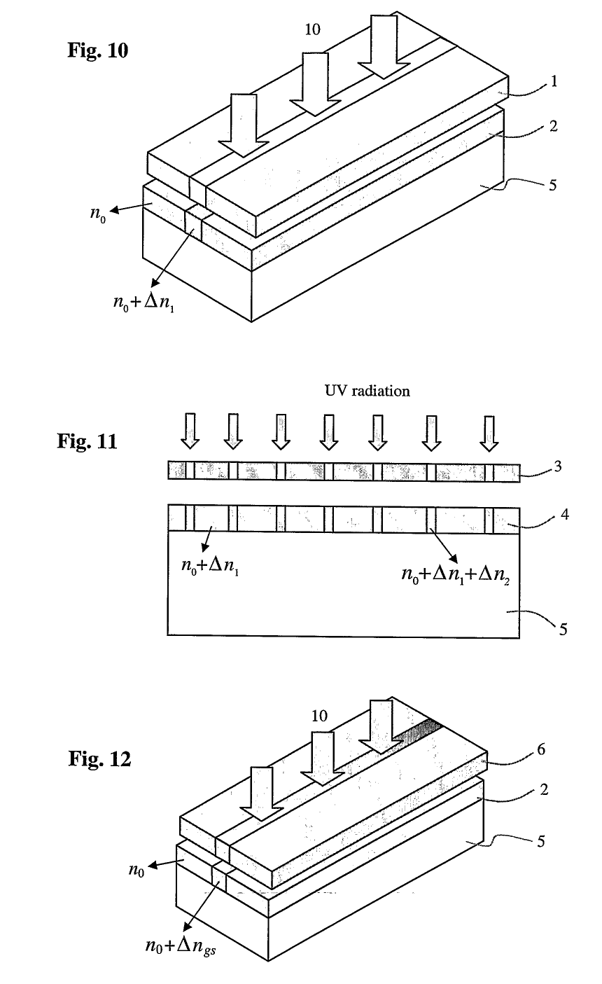

In some embodiments a certain area of the germanosilicate is selected which is exposed to UV-light as described above, while the remaining area of the germanosilicate is not exposed to UV light. An exemplary means to achieve radiation of a selected area is the use of a mask (cf. FIG. 10). Such a mask may cover an area of the germanosilicate, for instance a layer, so that it cannot be exposed to UV radiation, for example from a certain angle. A respective mask may therefore be patterned to define the area in which a refractive index change is generated upon exposing the germanosilicate to UV light. Irradiation will then change the refractive index of the region formed by the mask. A further exemplary means of achieving radiation of a selected area is the use of a lens that focuses the UV light to a selected area of the germanosilicate. A respective area on the germanosilicate, which is UV-irradiated, may for instance have the form of a channel region of a channel waveguide. Long-term storage data have shown that the high refractive index change obtained in germanosilicate by means of the method of the present invention is stable.

Where desired, the UV-radiated germanosilicate may furthermore be exposed to a subsequent exposure to an elevated temperature. In some embodiments such a further exposure to an elevated temperature may provide additional stability to the generated germanosilicate, including the obtained refractive index change. Any desired temperature and time period may be selected for such treatment with an elevated temperature, as long as a desired refractive index is maintained. As an example, a postbake may be performed at a temperature in the range of about 100 to about 300° C. and for a time period of about 0.5 hours to about two days. In this regard it should be noted that a prolonged exposure to temperatures in the dimension of the annealing or consolidation temperature may reverse the obtained refractive index change in some atmospheres (cf. FIG. 8).

The method of the present invention may be used to generate photonics components on a single substrate. Examples of optical components that may be obtained by the method of the present invention include for instance power splitters, couplers, Y branches etc. Accordingly, the method may be used to generate, e.g. fabricate, a light wave circuit, such as planar light wave circuit. An illustrative example of a planar light wave circuit is a waveguide, for instance a channel waveguide. A respective light wave circuit may for instance be included in a photonic integrated circuit device and/or combined with an optical fiber. Thus the present invention also provides a method of fabricating a waveguide. As explained above, for forming a respective waveguide a sol may for example be deposited on a substrate, turned into a gel, annealed and radiated with UV light of at least 350 mJ/pulse. In embodiments where the waveguide is a channel waveguide, an area of the germanosilicate may be irradiated in order to form the respective channel region of the waveguide (supra).

Where desired, a subsequent further UV illumination may be applied in order to generate additional areas with a refractive index change, for example in order to generate a waveguide with gratings. As an example, this may again be achieved by means of a respective mask (cf. FIG. 11). In some embodiments an overcladding layer may be applied to the produced germanosilicate, for instance to a produced germanosilicate waveguide. Furthermore, the method of the present invention provides a convenient means of generating graded index waveguides. The graded index may for instance be formed by exposing the obtained germanosilicate to UV radiation through a grey scale mask (cf. FIG. 12). The manufacture of such waveguides has so far been difficult and expensive.

The present invention thus provides a method that avoids techniques which involve multi-step processes for defining waveguide patterns in the films obtained. The devices are thus easy to fabricate as complex photolithography and etching steps are avoided. An additional advantage of using the direct UV writing technique is its ability to form smooth interfaces in the buried channel waveguides.

Furthermore, the generation of groves and/or channels by means of etching—when using conventional methods of forming waveguides such as flame hydrolysis deposition and etching—leads to surface roughness and hence optical loss, once the respective waveguide is in use. The method of the present invention overcomes these difficulties since it does not require the formation of a physical interface.

While other processes may be contemplated or used, it should be apparent from above that there is presently a need to exploit the advantages of the sol-gel process. The present invention thus allows for the use of silica (SiO₂) glasses containing germanium dioxide as a photosensitive material for direct UV writing instead of the presently used polymers or organic materials. The invention thereby also provides a means of forming waveguiding channels using germanosilicate. It should be understood that the method of the present invention is not restricted to germanosilicate or material that includes germanosilicate, but that it is of a general applicability and also suitable for other materials.

In order that the invention may be readily understood and put into practical effect, particular embodiments will now be described by way of the following non-limiting examples.

### EXAMPLES

### Example 1

### Fabrication of Highly Photosensitive Films

Photosensitive germanosilicate layers were prepared using the sol-gel technique shown schematically in FIG. 16. As the silica (SiO₂) precursor tetraethoxysilane (TEOS, 99.99% purity from Aldrich) was used, and as the germanium oxide (GeO₂) precursor tetrapropyloxygermane (TPOG, 99.99% purity from Chemat Technology Inc.), to prepare germanosilicate. A composition of 80% mole SiO₂ and 20% mole GeO₂ (4 SiO₂ : 1 GeO₂) was chosen unless stated otherwise.

TEOS and EtOH (ethanol) were mixed in 1:1 ratio by volume. For hydrolysis, acid catalyst HNO₃ (nitric acid) was added to maintain pH equal to 3 and water to alkoxide molar ratio (R) of 2. The pH level was measured using a Cyberscan pH2000 pH meter supplied by Eurotech with the combination of glass electrodes from Orion Research Inc. The solution was stirred continuously. This sol is called sol S. For the dopant, a sol called sol G was prepared by mixing TPOG with isopropanol (IPA) in 1:1 volume ratio. As TPOG is very reactive no catalyst was required. Furthermore the reactions were performed in a dry glove box maintained at relative humidity (RH) about 15% by continuous flushing of dry nitrogen. Sol G and sol S were then mixed to obtain a 4 SiO₂: 1 GeO₂ composition (sol SG) and vigorously stirred.

Films were prepared by spin coating sol SG on a substrate (e.g. Si wafer or silica plate). The spin coated films were heat treated using the rapid thermal processing (RTP) technique in a JIPELEC rapid thermal processor (RTP) for 15 s in the presence of an O₂ atmosphere. In order to obtain dense films for the fabrication of PLC, films were annealed at 900° C. and above. Some of the as-deposited films annealed at 900° C. in RTP were further heat treated in a furnace for 1 hour in at various temperatures ranging from 1000° C. to 1200° C. (consolidation). Thick films (e.g. of 3 or 5 μm) were generated by repetitive spin coating and annealing. Each spin coated layer was annealed in RTP. Thick films were usually subsequently exposed to a consolidation heat treatment. For a thick film, the refractive index change (after UV exposure, cf. below) was found to be 10⁻³ or larger (e.g. 5×10⁻³ or larger).

The films were then radiated by KrF excimer laser (λ=248 nm) operating at 10 Hz repetition rate at a UV fluency of 450 mJ/pulse with a beam size of about 24 mm×12 mm. Different exposure times were selected as indicated in the figures, usually the exposure time was varied from 1 minute to 60 minutes, since the refractive index changes can be easily adjusted by varying the exposure time. Films (e.g. thick films) may be irradiated for several hours. To stabilize the samples, they were post baked at 140° C. for periods of 1 hour to 24 hours under vacuum.

### Example 2

### Fabrication of Gratings on Waveguides

Using the highly photosensitive materials obtainable by the method of the invention, gratings on waveguides can be easily fabricated as follows:

The highly photosensitive layer (2) is deposited and fabricated on a substrate (5) as described above. To fabricate a waveguide, the highly photosensitive film is then radiated by UV light (10) through a mask (1) as shown in FIG. 10. The refractive index n₀ is the refractive index of the densified photosensitive film before UV radiation. The refractive index change due the UV radiation, Δn₁, can be easily adjusted by varying the exposure time using results such as depicted in FIG. 2.

Having formed the waveguide, the gratings can be fabricated by further radiating the waveguide by UV light, for the second time, through a mask (3) defining the gratings (see FIG. 11). Further increase of the refractive index Δn₂ can again be easily adjusted by varying the exposure time using results such as depicted in FIG. 2.

A cladding layer may be deposited. Using the technique described above, the deposition of the cladding layer is very easy and leads to better performance devices since there are no steps in the waveguides and gratings like those fabricated using the conventional etching technique.

### Example 3

### Fabrication of Graded Index Waveguides

Using the above indicated photosensitive materials, graded index waveguides can be easily fabricated as follows:

The highly photosensitive layer (2) is deposited and fabricated on a substrate (5) as described above. To fabricate a graded index waveguide, the highly photosensitive film is radiated by a UV light (10) through a grey scale mask (6) as shown in FIG. 12. The refractive index n₀ is the refractive index of the densified photosensitive film before UV radiation. The refractive index change due the UV radiation through the grey scale mask, Δn_{gs}, is a function of the transmission of the grey scale mask and the exposure time.

A cladding layer may be deposited. As above, the deposition of the cladding layer is easy and leads to better performance devices since there are no steps in the waveguides.

1. A method of producing germanosilicate that comprises a refractive index change Δn, the method comprising:
forming a gel from a sol comprising germaniumoxide, or a precursor thereof, and silicate, or a precursor thereof, by means of a sol-gel process,
forming germanosilicate by annealing said gel under elevated temperature, and
exposing said germanosilicate to UV light of an energy of at least 350 mJ/pulse.

2. The method of claim 1, wherein the UV light is of at least 450 mJ/pulse.

3. The method of claim 1 wherein said elevated temperature ranges from about 500° C. to about 1000° C.

4. The method of claim 3, wherein said elevated temperature ranges from about 800° C. to about 1000° C.

5. The method of claim 4, wherein said elevated temperature is about 900° C.

6. The method of claim 1 wherein the wavelength of said UV light is selected to be 248 nm or shorter.

7. The method of claim 1, wherein said UV light is pulsed.

8. The method of claim 1, wherein the UV light is of at least 122 mJ/cm² per pulse.

9. The method of claim 8, wherein the UV light is of at least 156 mJ/cm² per pulse.

10. The method of claim 1, wherein said UV light is provided by means of a laser.

11. The method of claim 10, wherein said laser is a KrF laser or an ArF laser.

12. The method of claim 1, wherein the time of exposing said germanosilicate to said pulsed UV light ranges from about 0.5 minutes to about 5 hours.

13. The method of claim 12, wherein the time of exposing said germanosilicate to said UV light ranges from about 1 minute to about 1 hour.

14. The method of claim 1, wherein forming said gel from a sol comprises contacting said sol with a substrate.

15. The method of claim 14, wherein contacting said sol with a substrate comprises depositing said sol onto a substrate.

16. The method of claim 15, wherein said sol is deposited by means of coating.

17. The method of claim 16, wherein said coating is spin-coating.

18. The method of claim 1, wherein said refractive index change is generated within an area of the germanosilicate.

19. The method of claim 18, wherein said area is defined by means of a mask upon exposing said germanosilicate to said pulsed UV light.

20. The method of claim 1, wherein the ratio of silicate to germaniumoxide in forming said germanosilicate is about 4:1.

21. The method of claim 1, wherein the precursor of the silicate is a silicon alkoxide.

22. The method of claim 1, wherein the precursor of the germaniumoxide is a germanium alkoxide.

23. The method of claim 1, wherein the annealed germanosilicate is consolidated by a second exposure to an elevated temperature prior to exposing the germanosilicate to UV light.

24. The method of claim 23, wherein consolidation is carried out at a temperature higher than the temperature used for annealing.

25. The method of claim 24, wherein the germanosilicate is consolidated at a temperature below 1100° C.

26. A method of forming a waveguide, comprising:
forming a gel from a sol comprising germaniumoxide, or a precursor thereof, and silicate, or a precursor thereof, by means of a sol-gel process;
forming germanosilicate by annealing said gel under elevated temperature; and
exposing said germanosilicate to UV light of at least 350 mJ/pulse;
wherein forming said gel by means of a sol-gel process comprises:
providing a substrate; and
depositing said sol onto the substrate.

27. The method of claim 26, wherein the waveguide is a channel waveguide.

28. The method of claim 26, wherein the annealed gel is consolidated by a further exposure to an elevated temperature.

29. The method of claim 26, wherein the annealed gel is covered by a mask that is patterned to form on the germanosilicate the channel region of the waveguide upon exposure to UV light.

30. Germanosilicate comprising a refractive index change Δn, obtainable by the method of claim 1.

31. The germanosilicate of claim 30, wherein the refractive index change is more than 10⁻³.

32. A waveguide obtainable by the method of claim 1.
